(19) United States
(12) Patent Application Publication
(10) Pub. No.: US 2020/0203037 A1
(43) Pub. Date: Jun. 25, 2020

(54) WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Koji YAMAGUCHI, Mie (JP); Housei MIZUNO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/640,572

(22) PCT Filed: Jun. 15, 2018
(86) PCT No.: PCT/JP2018/022939

§ 371 Date: Feb. 20, 2020

(30) Foreign Application Priority Data
Aug. 28, 2017 (JP) 2017-163305

(51) Int. Cl. H01B 7/00; H01B 7/40; H01B 7/08; H02G 3/30; B60R 16/02

(52) U.S. Cl. CPC H01B 7/0045; H01B 7/40; B60R 16/0215; H02G 3/30; H01B 7/0846

(57) ABSTRACT

A wire harness includes a base material and electrical wires including a first electrical wire and a second electrical wire and disposed to be stacked in layers on the base material. A fixing means in a first fixing position for keeping the first electrical wire disposed on the base material and a fixing means in a second fixing position for keeping the second electrical wire disposed on the first electrical wire are different from each other.

### TECHNICAL FIELD

The present invention relates to a technique of keeping a wire harness disposed in a vehicle as flat as possible.

### BACKGROUND ART

Patent Document 1 discloses a flat cable in which an insulating covering is collectively applied to outer peripheries of a plurality of core wires as a technique of keeping a plurality of electrical wires flat.

However, it is difficult in the flat cable to freely change the number of electrical wires compared to a case of using a plurality of sole electrical wires, so that the flat cable lacks versatility.

### PRIOR ART DOCUMENTS

### Patent Documents

Patent Document 1: Japanese Patent Application. Laid-Open No. 2010-135203

### SUMMARY

### Problem to be Solved by the Invention

Thus, the applicant of the present application proposes a technique of flatly arranging electrical wires on a base material as a technique of keeping a plurality of electrical wires flat. This case can easily meet the increase in the number of electrical wires.

However, when the electrical wires are arranged on the base material in only one layer, there is a possibility that a ratio of the electrical wires to the base material becomes too large or an area of the base material becomes too large in a case where the number of electrical wires increases. When the electrical wires are stacked in layers to prevent the above problem, there may be difficulty in fixing the electrical wires in accordance with conditions in a case where the same fixation means is applied as a means of fixing the electrical wires and the base material and a means of fixing the electrical wires in adjacent layers.

Thus, an object of the present invention is to provide a technique capable of easily stacking electrical wires on a base material.

### Means to Solve the Problem

In order to solve the above problem, a wire harness according to a first aspect includes; a base material; and electrical wires including a first electrical wire and a second electrical wire and disposed to be stacked in layers on the base material, wherein a fixing means in a first fixing position for keeping the first electrical wire disposed on the base material and a fixing means in a second fixing position for keeping the second electrical wire disposed on the first electrical wire are different from each other.

The wire harness according to a second aspect is the wire harness according to the first aspect, wherein two fixing means of a first fixing means using a sewing by a thread, a second fixing means using ultrasonic welding, and a third fixing means using an inclusion having adhesiveness or stickiness are adopted as the fixing means in the first fixing position and the second fixing position.

The wire harness according to a third aspect is the wire harness according to the second aspect, wherein the fixing means in the first fixing position is the first fixing means or the third fixing means.

The wire harness according to a fourth aspect is the wire harness according to the third aspect, wherein the fixing means in the first fixing position is the first fixing means, and the fixing means in the second fixing position is the second fixing means.

The wire harness according to a fifth aspect is the wire harness according to any one of the first to fourth aspects further including a reinforcement member formed to have a height dimension larger than a height of the electrical wires which is stacked, and provided on both sides of the electrical wires on the base material.

### Effects of the Invention

According to the first to fifth aspects, the different fixing means can be used in accordance with each fixing position. Accordingly, the electrical wire can be easily stacked on the base material.

Particularly, according to the second aspect, the relatively simple fixing means can be used as the plurality of different fixing means.

Particularly, according to the third aspect, when the base material is relatively thick and has flexibility such as an acoustic insulation material, for example, it may be difficult to the ultrasonic-weld the electrical wire in some cases. Even in this case, the base material and the electrical wire can be fixed reliably by sewing or bonding, for example.

Particularly, according to the fourth aspect, a wide range of materials can be used as a material of the base material as long as the needle can pass through the base material, for example, in the fixation in the first fixing position. When the electrical wires having the insulating covering made of the same material are used in the first electrical wire and the second electrical wire, for example, the first electrical wire and the second electrical wire can be fixed relatively firmly without using the other member in the fixation in the second fixing position.

When the electrical wire is stepped in a state where the electrical wire is fixed to and stacked on the base material, for example, there is a possibility that the electrical wire cannot absorb an impact of the stepping sufficiently, and is damaged. Even in such a case, according to the fifth aspect, the reinforcement member is provided, thereby being able to suppress an excess force on the electrical wire.

### BRIEF DESCRIPTION OF DRAWINGS

FIG. 1 A perspective view illustrating a wire harness according to a first embodiment.

FIG. 2 An explanation diagram illustrating a manufacture of the wire harness according to the first embodiment.

FIG. 3 An explanation diagram illustrating a manufacture of the wire harness according to the first embodiment.

FIG. 4 A schematic cross-sectional view illustrating a modification example of the wire harness according to the first embodiment.

FIG. 5 An explanation diagram illustrating a manufacture of a wire harness according to a second embodiment.

FIG. 6 An explanation diagram illustrating a manufacture of the wire harness according to the second embodiment.

FIG. 7 A schematic cross-sectional view illustrating a modification example of the wire harness according to the second embodiment.

FIG. 8 An explanation diagram illustrating a manufacture of a wire harness according to a third embodiment.

FIG. 9 An explanation diagram illustrating a manufacture of the wire harness according to the third embodiment.

FIG. 10 A schematic cross-sectional view illustrating a modification example of the wire harness according to the third embodiment.

FIG. 11 An explanation diagram illustrating a manufacture of a wire harness according to a fourth embodiment.

FIG. 12 A schematic cross-sectional view illustrating a modification example of the wire harness according to the fourth embodiment.

FIG. 13 A schematic planar view illustrating a wire harness according to a first modification example.

FIG. 14 A schematic cross-sectional view illustrating a wire harness according to a second modification example.

FIG. 15 A schematic cross-sectional view illustrating a wire harness according to a third modification example.

### DESCRIPTION OF EMBODIMENT(S)

### First Embodiment

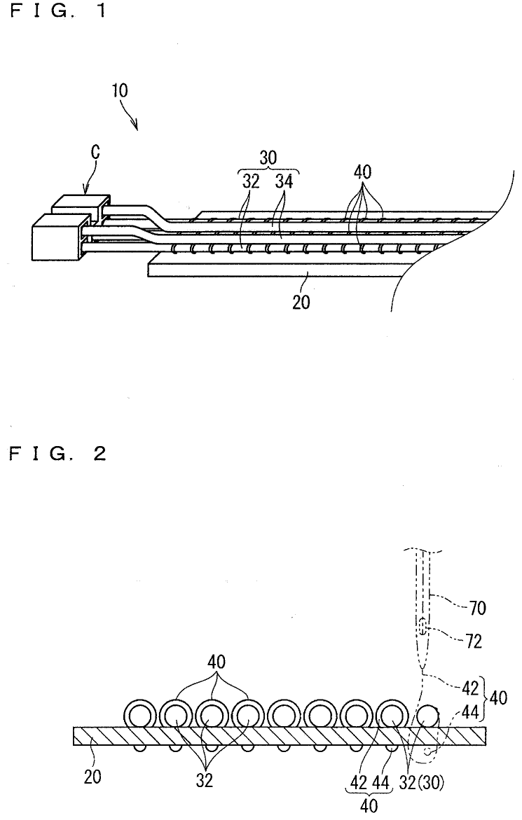

A wire harness according to a first embodiment is described hereinafter. FIG. 1 is a perspective view of a wire harness 10 according to the first embodiment. FIG. 2 and FIG. 3 are explanation diagrams each illustrating a manufacture of the wire harness 10 according to the first embodiment.

The wire harness 10 includes a base material 20 and electrical wires 30.

Any base material 20 is applicable as long as some of the electrical wires 30 can be flatly disposed. Thus, a shape and a material, for example, are not particularly limited, but are appropriately set in accordance with a function of the base material 20. There may be a case where the base material 20 has a function other than the function of keeping the disposed electrical wires 30 flat. Considered as such a function in the base material 20 are, for example, one or a plurality of protection, heat insulation, heat shielding, heat radiation, acoustic insulation, waterproof, electromagnetic shield, a tension member for reducing a tensional force on the electrical wires 30.

For example, considered is that the base material 20 is an acoustic insulation material, particularly, a silencer disposed on a floor of a vehicle. In this case, it is considered that a member made up of a non-woven cloth or a fiber compressed and fixed by an adhesive agent or a foam resin or a chip of foam resin compressed and fixed, for example, is used as the base material 20. In this case, the base material 20 is considered a relatively soft and relatively thick member.

For example, also considered is a case where the base material 20 is a protection sheet. In this case, it is considered that a sheet material having a uniform filled cross section made up of an extrusion-molded resin or a non-woven cloth, for example, is used as the base material 20.

The base material 20 may be made up of one member, or may also be made up of a plurality of members, each having a different function, stacked in layers.

The electrical wires 30 are stacked in layers and disposed on the base material 20. The electrical wires 30 include a first electrical wire 32 and a second electrical wire 34. The first electrical wire 32 is an electrical wire disposed on the base material 20. The second electrical wire 34 is an electrical wire disposed on the first electrical wire 32. In the example illustrated in FIG. 3, the second electrical wire 34 is located between the adjacent two first electrical wires 32, and has direct contact with the adjacent two first electrical wires 32, however, this configuration is not necessary. There may also be a case where the second electrical wire 34 has direct contact with only one first electrical wire 32. In the example illustrated in FIG. 3, the second electrical wire 34 is formed larger than the first electrical wire 32 having direct contact with the second electrical wire 34, however, this configuration is not necessary. The second electrical wire 34 may be formed equal to or smaller than the first electrical wire 32 having direct contact with the second electrical wire 34. In the example illustrated in FIG. 3, a plurality of electrical wires as the first electrical wires 32 are all formed to have the same size, however, this configuration is not necessary. Electrical wires each having a different size may be provided as the first electrical wires 32. The same applies to the second electrical wire 34.

In the description hereinafter, each electrical wire 30 is an insulated electrical wire including a core wire and an insulating covering for covering the core wire. The core wire may be a single wire or made up of a set of a plurality of single wires. When the set of the plurality of single wires is applied, the wires may be or may not be stranded. The insulating covering may be formed by extrusion molding a resin, for example, around the core wire or by applying a resin coating around the core wire. There may also be a case where a wire which does not include the insulating covering, a so-called a bare wire, is adopted to some of the electrical wires 30. Also in this case, at least one of the electrical wires 30 having direct contact with each other is the insulating wire.

In the description herein, the first electrical wire 32 and the second electrical wire 34 constantly extend along the same path on the base material, however, this configuration is not necessary. There may also be a case where the first electrical wire 32 and the second electrical wire 34 extends along different paths in part of section on the base material. This configuration is described in detail hereinafter.

In the example illustrated in FIG. 1, an end portion of the first electrical wire 32 and an end portion of the second electrical wire 34 are connected to the same member (a connector C in the example illustrated in FIG. 1), however, this configuration is not necessary. There may also be a case where the end portion of the first electrical wire 32 and the end portion of the second electrical wire 34 are connected to different members.

In the present specification, a fixing position in which a fixing means for keeping the first electrical wire 32 disposed on the base material 20 is referred to as a first fixing position. In the similar manner, a fixing position in which a fixing means for keeping the second electrical wire 34 disposed on the first electrical wire 32 is referred to as a second fixing position. In the wire harness 10, the fixing means in the first fixing position and the fixing means in the second fixing position are different from each other. The first electrical wire 32 and the base material 20 are fixed to each other in the first fixing position. The second electrical wire 34 and the first electrical wire 32 or the base material 20 are fixed to each other in the second fixing position.

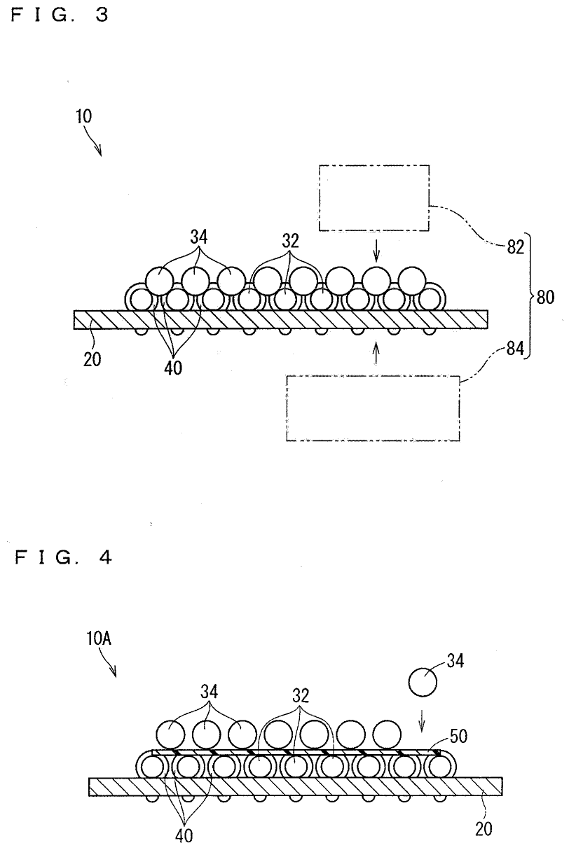

Herein, in the present specification, a fixing means using a sewing by a thread 40 is referred to as a first fixing means. In the similar manner, a fixing means using an ultrasonic welding is referred to as a second fixing means. In the similar manner, a fixing means using an inclusion 50 (refer to FIG. 4) having adhesiveness or stickiness is referred to as a third fixing means.

Herein, two fixing means of the first fixing means, the second fixing means, and the third fixing means are adopted as the fixing means in the first fixing position and the second fixing position. The present embodiment describes an example of using the first fixing means as the fixing means in the first fixing position. A second embodiment describes hereinafter details of an example of using the third fixing means as the fixing means in the first fixing position, and a third embodiment describes hereinafter details of an example of using the second fixing means as the fixing means in the first fixing position.

The first fixing means is the fixing means using the sewing by the thread 40 as described above. More specifically, as illustrated in FIG. 2, in a state where the thread 40 is inserted into an insertion hole 72 formed in a tip of a needle 70, the tip of the needle 70 into which the thread 40 is inserted is passed through the base material 20, thus the sewing by the thread 40 can be performed. Accordingly, the base material 20 is formed so that the tip of the needle 70 can be passed through the base material 20 herein. At this time, a sewing method is not particularly limited. For example, also applicable are a lockstitch using a sewing machine, a chain stitch using a sewing machine as is the case for the lockstitch, and hand-stitch not using the sewing machine. At this time, the thread 40 corresponding to one stitched seam may be made up of one thread, or two or more threads may also be applicable. Generally, in the case of the hand-stitch or the chain stitch by the sewing machine, the thread 40 corresponding to one stitched seam is made up of one thread, and in the case of the lockstitch by the sewing machine, the thread 40 corresponding to one stitched seam is made up of two thread of a needle thread 42 inserted into the needle 70 and a bobbin thread 44 going through a loop of the needle thread 42. The example in FIG. 2 illustrates the lockstitch. Accordingly, the thread 40 is made up of the two threads of the needle thread 42 and the bobbin thread 44. When the electrical wire 30 is sewn by the lockstitch using the sewing machine, a needlework sewing machine for sewing a stitch thread onto the base material by the lockstitch can reel out and sew the electrical wire 30 onto the base material 20 using the electrical wire 30 instead of a stitch thread.

When the electrical wire 30 is sewn by the thread 40, it is applicable to sew only one electrical wire 30 by the same thread 40 or collectively sew the plurality of electrical wires 30 arranged in parallel with each other by the same thread 40. A pitch of the sewing, for example, is appropriately set, thus there may also be a case where the pitch changes halfway through the sewing. For example, when the electrical wire 30 includes a portion curvedly disposed and a portion linearly disposed, considered is a case where pitches in the two portions are different from each other such as a case where a pitch in the portion where the electrical wire 30 is curvedly disposed is smaller or larger than a pitch in the portion where the electrical wire 30 is linearly disposed.

The first electrical wire 32 may be continuously sewn by the same thread in a longitudinal direction, or may also be intermittently sewn by the different thread 40 in the longitudinal direction, that is to say, sewn by the different thread 40 in sewing regions adjacent to each other. When the first electrical wire 32 is intermittently sewn in the longitudinal direction, a size of one sewing region and an interval between the adjacent sewing regions, for example, are appropriately set.

The present embodiment describes an example that the fixing means in the second fixing position is the second fixing means. There may also be a case where the fixing means in the second fixing position is the third fixing means. This example is described in detail hereinafter.

The second fixing means is the fixing means using the ultrasonic welding as described above. More specifically, as illustrated in FIG. 3, the ultrasonic welding can be performed by sandwiching an object to be fixed by a horn 82 and an anvil 84 in an ultrasonic welding machine 80 and applying ultrasonic vibration to the object to be fixed. Herein, the horn 82 is a member which is ultrasonic-vibrated. The horn 82 can apply the ultrasonic vibration to a member having direct contact with the horn 82. The anvil 84 is a member provided in a position facing the horn 82 to sandwich the object to be fixed with the horn 82 from an opposite side of the horn 82.

In the present embodiment, the second fixing means is used as the fixing means in the second fixing position. Thus, as illustrated in FIG. 3, it is preferable that the horn 82 is located on a side of the second electrical wire 34 and the anvil 84 is located on a side of the base material 20. Accordingly, the ultrasonic vibration from the horn 82 can be transmitted to the second fixing position more effectively compared to a case where the arrangement of the horn 82 and the anvil 84 is reversed.

There may be a case where processing such as so-called knurling is performed on a surface of the horn 82 having direct contact with the object to be fixed for preventing a slippage of the object to be fixed, thus a small uneven shape is uniformly formed on the surface. In this case, there may be a case where a mark corresponding to the uneven shape of the horn 82 (referred to as a horn mark hereinafter) remains on the member to which the horn 82 is applied. Accordingly, there may be a case where the horn mark remains on a surface of the second electrical wire 34 directed to a side opposite to a side of the first electrical wire 32 herein.

In the ultrasonic welding of the first electrical wire 32 and the second electrical wire 34, it is preferable that the insulating covering of the first electrical wire 32 and the insulating covering of the second electrical wire 34 are made of the same type of material, and it is more preferable that they are made of the same material. Accordingly, when the first electrical wire 32 and the second electrical wire 34 are ultrasonic-welded, both the insulating covering of the first electrical wire 32 and the insulating covering of the second electrical wire 34 can be melted and further can be relatively uniformly mixed, thus a bonding strength can be increased.

The horn 82 may be applied to only one second electrical wire 34 to ultrasonic-weld the one second electrical wire 34, or may also be applied to the plurality of electrical wires 34 to collectively ultrasonic-weld the plurality of electrical wires 34.

The second electrical wire 34 may be continuously ultrasonic-welded in the longitudinal direction, or may also be intermittently ultrasonic-welded in the longitudinal direction. When the second electrical wire 34 is intermittently ultrasonic-welded in the longitudinal direction, a size of one ultrasonic welding region and an interval between the adjacent ultrasonic welding regions, for example, are appropriately set.

Adopted herein is the first fixing means using the sewing by the thread 40 as the fixing means in the first fixing position. Thus, there is a portion where the thread 40 intervenes between the first electrical wire 32 and the second electrical wire 34. In this case, the first electrical wire 32 and the second electrical wire 34 need to be ultrasonic-welded in a portion where the thread 40 does not intervene.

In the ultrasonic welding of the first electrical wire 32 and the second electrical wire 34, there may also be a case where the thread 40 sewing the first electrical wire 32 is also welded to one of or both the first electrical wire 32 and the second electrical wire 34. At this time, when the thread 40 sewing the first electrical wire 32 is welded to both the first electrical wire 32 and the second electrical wire 34, the first electrical wire 32 and the second electrical wire 34 are bonded via the thread 40. There may also be a case where the thread 40 sewing the first electrical wire 32 is not welded to the electrical wire 30.

FIG. 4 illustrates a schematic cross-sectional view of a modification example of the wire harness 10 according to the first embodiment.

A wire harness 10A according to the modification example is an example that the fixing means in the second fixing position is the third fixing means.

The third fixing means is the fixing means using the inclusion 50 having the adhesiveness or the stickiness as described above. For example, an adhesive agent or a double-sided adhesive tape is used as the inclusion 50. When the double-sided adhesive tape is used as the inclusion 50, the electrical wire can be easily provided by applying the tape, and a curing process can be omitted. When the adhesive agent is used as the inclusion 50, a gap can be filled or an adhesion area can be increased.

When the inclusion 50 is used, the inclusion 50 may be previously provided on the first electrical wire 32 or the inclusion 50 may be previously provided on the second electrical wire 34. In the example illustrated in FIG. 4, the double-sided adhesive tape as the inclusion 50 is previously provided on the first electrical wire 32. At this time, one relatively large double-sided adhesive tape capable attaching the plurality of second electrical wires 34 is previously provided on the first electrical wire 32. A plurality of double-sided adhesive tapes, each of which is smaller than that described above, may be provided, or it is also applicable that one double-sided adhesive tape corresponds to one electrical wire 30. However, when one relatively large double-sided adhesive tape is previously provided on the first electrical wire 32, a process of attaching the double-sided adhesive tape can be simplified compared to a case where the plurality of double-sided adhesive tapes, each of which is smaller than that described above, are provided.

The inclusion 50 may be continuously disposed on the second electrical, wire 34 in the longitudinal direction, or may also be intermittently disposed in the longitudinal direction. When the inclusion 50 is intermittently disposed in the longitudinal direction, a length of a region where one inclusion 50 is provided and an interval between the adjacent regions where the inclusion 50 is provided, for example, are appropriately set.

### Second Embodiment

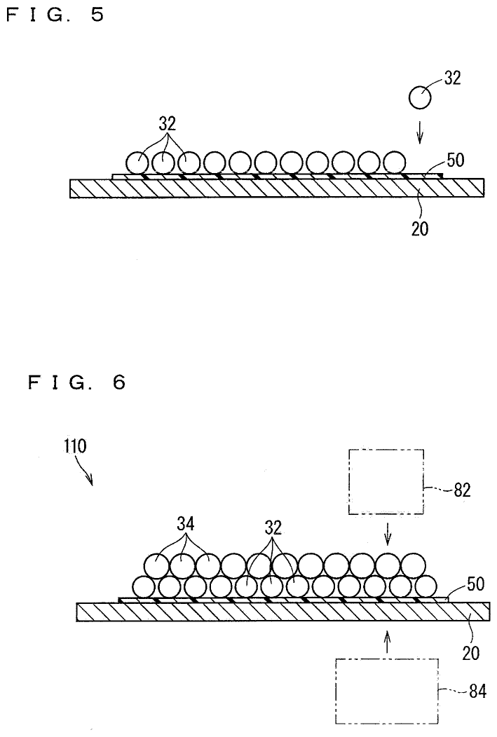

A wire harness according to a second embodiment is described. FIG. 5 and FIG. 6 are explanation diagrams each illustrating a manufacture of a wire harness 110 according to the second embodiment. In the description of the present embodiment, the same reference numerals are assigned to the similar constituent elements described above, and the description thereof will be omitted. The same applies to the description of each embodiment hereinafter.

As described above, the present embodiment describes an example of using the third fixing means as the fixing means in the first fixing position. The first fixing position can be fixed by the third fixing means, using a method similar to the case of fixing the second fixing position by the third fixing means in the wire harness 10A described above.

At this time, one relatively large double-sided adhesive tape is used as the inclusion 50 herein to be able to attach the plurality of first electrical wires 32 in the manner similar to the inclusion 50 in the wire harness 10A, however, this configuration is not necessary. For example, the inclusion 50 may have a size capable of attaching only one first electrical wire 32. For example, an adhesive agent may be the type of the inclusion 50.

The present embodiment describes an example of using the second fixing means as the fixing means in the second fixing position. There may also be a case where the fixing means in the second fixing position is the first fixing means. This example is described in detail hereinafter.

The second fixing position can be fixed by the second fixing means, using a method similar to the case of fixing the second fixing position by the second fixing means in the wire harness 10 described above.

At this time, the fixing means in the first fixing position is the third fixing means herein, thus the thread 40 is not used for fixing the first electrical wire 32. As a result, an area where the first electrical wire 32 and the second electrical wire 34 have direct contact with each other without the thread 40 increases compared to the wire harness 10 described above. Thus, an area of the ultrasonic welding between the first electrical wire 32 and the second electrical wire 34 can be increased compared to the case where the thread 40 is not welded in the wire harness 10 according to the first embodiment.

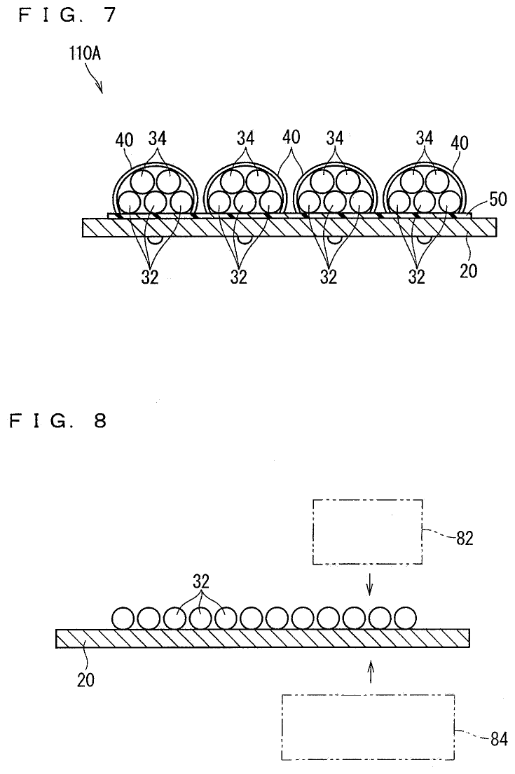

FIG. 7 illustrates a schematic cross-sectional view of a modification example of the wire harness 110 according to the second embodiment.

A wire harness 110A according to the present modification example is an example that the fixing means in the second fixing position is the first fixing means. The second fixing position can be fixed by the first fixing means, using a method similar to the case of fixing the first fixing position by the first fixing means in the wire harnesses 10 and 10A described above.

At this time, the thread 40 also rolls the first electrical wire 32 together and is sewn to the base material 20 herein. Accordingly, not only the second electrical wire 34 but also the first electrical wire 32 are sewn by the thread 40. It is also applicable that the thread 40 does not roll the first electrical wire 32 together but sews only the second electrical wire 34 to the base material 20. This configuration is described in detail hereinafter.

Furthermore, the fixing means in the first fixing position is the third fixing means herein, thus the inclusion 50 is provided on the base material 20. At this time, in the example illustrated in FIG. 7, the thread 40 passes through the inclusion 50. It is also applicable that there is a portion where the inclusion 50 is not provided on the base material 20 between the base material 20 and the first electrical wire 32, and the thread 40 is passed through a portion where the inclusion 50 is not provided on the base material 20.

### Third Embodiment

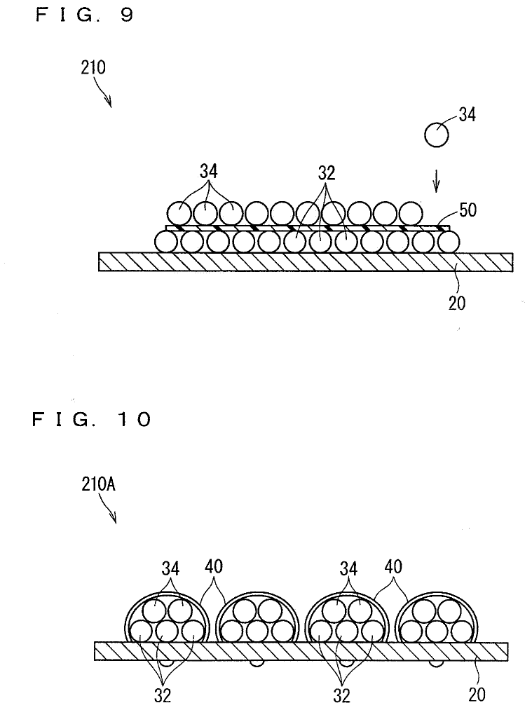

A wire harness according to a third embodiment is described. FIG. 8 and FIG. 9 are explanation diagrams each illustrating a manufacture of a wire harness 210 according to the third embodiment.

As described above, the present embodiment describes an example of using, the second fixing means as the fixing means in the first fixing position. The first fixing position can be fixed by the second fixing means, using a method similar to the case of fixing the second fixing position by the second fixing means in the wire harness 10 described above.

At this time, in the example illustrated in FIG. 8, the ultrasonic welding is performed in the state where the horn 82 is located on the side of the first electrical wire 32 and the anvil 84 is located on the side of the base material 20, however, the ultrasonic welding may be performed in a state where the horn 82 and the anvil 84 are located in the reverse position. That is to say, the ultrasonic welding may be performed in a state where the horn 82 is located on the side of the base material 20 and the anvil 84 is located on the side of the first electrical wire 32. Particularly, when a thickness of the base material 20 is small, the welding can be performed without increasing output power so much even in a case where the horn 82 is located on the side of the base material 20. When the horn 82 is located on the side of the base material 20, there may be a case where the horn mark remains on the base material 20.

The present embodiment describes an example of using the third fixing means as the fixing means in the second fixing position. The second fixing position can be fixed by the third fixing means, using a method similar to the case of fixing the second fixing position by the third fixing means in the wire harness 10A described above.

At this time, the fixing means in the first fixing position is the second fixing means herein, thus there is no thread 40 around the first electrical wire 32. Thus, an area where the inclusion 50 has direct contact with the first electrical wire 32 can be increased compared to the wire harness 10A described above. There is no possibility of a bulge of the inclusion 50 convexed to the side of the second electrical wire 34 due to the thread 40, thus the inclusion 50 uniformly has direct contact with the second electrical wire 34 easily.

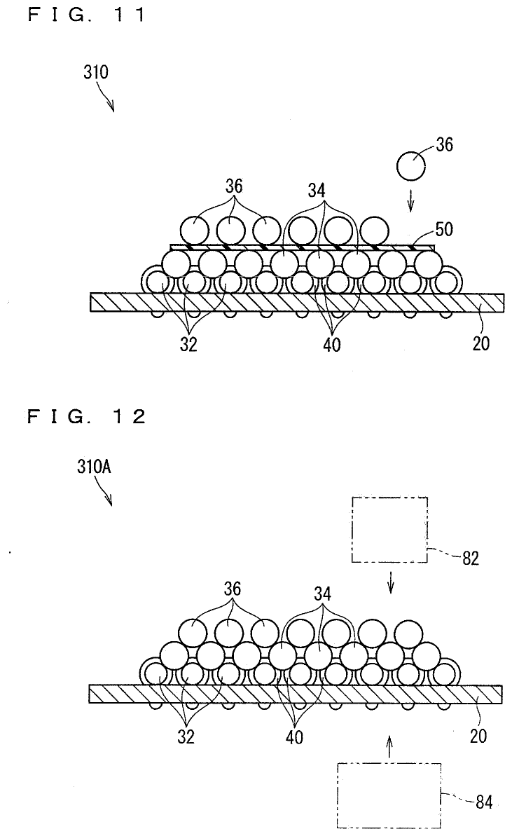

FIG. 10 is a schematic cross-sectional view illustrating a modification example of the wire harness 210 according to the third embodiment.

A wire harness 210A according to the present modification example is an example that the fixing means in the second fixing position is the first fixing means. The second fixing position can be fixed by the first fixing means, using a method similar to the case of fixing the second fixing position by the first fixing means in the wire harness 110A described above.

At this time, the fixing means in the first fixing position is the second fixing means herein, thus there is no inclusion 50 on the base material 20. Thus, the thread 40 needs not pass through the inclusion 50 compared to the wire harness 110A described above.

### Fourth Embodiment

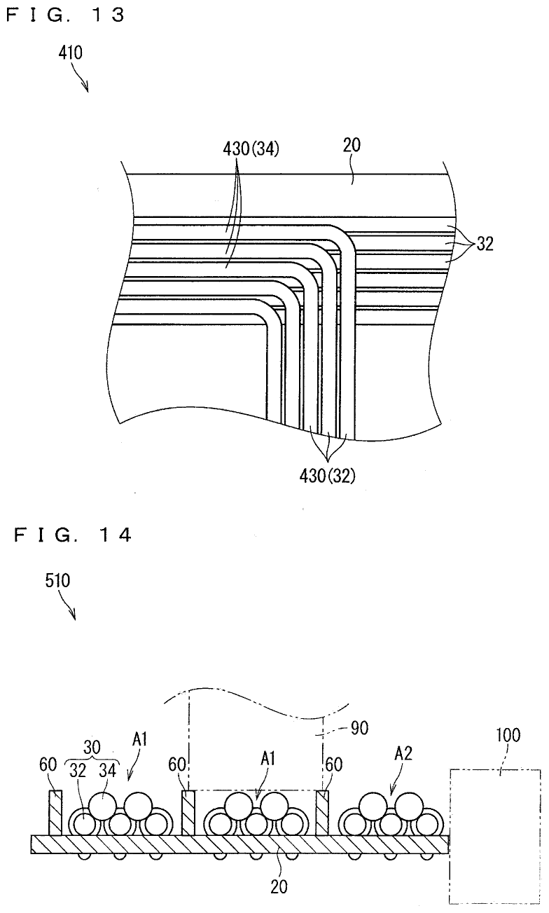

A wire harness according to a fourth embodiment is described. FIG. 11 is an explanation diagram illustrating a manufacture of a wire harness 310 according to the fourth embodiment. FIG. 12 is a schematic cross-sectional view illustrating a modification example of the wire harness 310 according to the fourth embodiment.

The wire harness 310 according to the present embodiment and a wire harness 310A according to a modification example of the wire harness 310 describe an example that the electrical wires 30 include a third electrical wire 36 disposed on the second electrical wire 34. In this manner, there may also be a case where the electrical wires 30 are stack in three or more layers.

A fixing position where a fixing means for fixing the third electrical wire 36 on the second electrical wire 34 is provided is referred to as a third fixing position. The fixing means in the third fixing position is not particularly limited, thus may be the same as the fixing means in the first fixing position and the fixing means in the second fixing position, or may be different from the fixing means in the first fixing position and the fixing means in the second fixing position.

More specifically, FIG. 11 and FIG. 12 illustrate an example that the third electrical wire 36 is further stacked on the wire harness 10 described above. At this time, adapted in the wire harness 310 illustrated in FIG. 11 are a fixing means that the fixing means in the third fixing position is the first fixing position and a fixing means different from the fixing means in the second fixing position. More specifically, the third fixing means is adopted as the fixing means in the third fixing position in the wire harness 310 illustrated in FIG. 12.

Adapted in the wire harness 10 illustrated in FIG. 12 is a fixing means that the fixing means in the third fixing position is the same as the fixing means in the second fixing position, that is to say, the second fixing means. In this manner, the second electrical wire 34 and the third electrical wire 36 can be disposed using the same facilities by using the fixing means that the fixing means in the third fixing position is the same as the fixing means in the second fixing position.

When the electrical wires 30 are stacked in more than several layers, there may also be a case where the electrical wires 30 located farther away from the base material 20 are not orderly arranged, but have direct contact with the electrical wires 30 in the several layers located nearer the side of the base material 20.

According to each embodiment described above, the first fixing position and the second fixing position are fixed by the different means, thus the different means can be used in accordance with each fixing position. Thus, the electrical wires 30 can be easily stacked on the base material 20.

The two fixing means of the first fixing means, the second fixing means, and the third fixing means are adopted as the plurality of different fixing means, thus the relatively simple fixing means can be used.

Herein, when the base material 20 is relatively thick and has flexibility such as an acoustic insulation material, for example, it may be difficult to the ultrasonic-weld the electrical wire 30 in some cases. Even in this case, when the fixing means in the first fixing position is the first fixing means or the third fixing means as is the case for the first embodiment or the second embodiment, the base material 20 and the electrical wire 30 can be fixed reliably by sewing or bonding, for example.

Particularly, in the wire harness 10 according to the first embodiment, a wide range of materials can be used as the material of the base material 20 as long as the needle can pass through the base material 20, for example, in the fixation in the first fixing position. When the electrical wires having the insulating covering made of the same material are used in the first electrical wire 32 and the second electrical wire 34, for example, the first electrical wire 32 and the second electrical wire 34 can be fixed relatively firmly without using the other member in the fixation in the second fixing position.

### Other Modification Example

FIG. 13 is a schematic planar view illustrating a wire harness 410 according to a first modification example.

In the above description, the first electrical wire 32 and the second electrical wire 34 are disposed along the same path on the base material 20, however, this configuration is not necessary. As illustrated in FIG. 13, there may also be a case where the first electrical wire 32 and the second electrical wire 34 are branched halfway. In this case, there may also be a case where an electrical wire 430 which has been the second electrical wire 34 on the same path as the first electrical wire 32 is disposed on the base material 20, that is to say, becomes the first electrical wire 32 after branching from the first electrical wire 32. As is this case, there may also be a case where the electrical wire 430 which has the role of the first electrical wire 32, the second electrical wire 34, or the third electrical wire 36 in a certain path has the other role of the first electrical wire 32, the second electrical wire 34, or the third electrical wire 36 in the other path.

In the description in the embodiment, the same fixing means is adopted for one electrical wire 30, however, this configuration is not necessary. There may also be a case where different fixing means are adopted for one electrical wire 30. Particularly, as illustrated in FIG. 13, when one electrical wire 430 has the other role of the first electrical wire 32, the second electrical wire 34, and the third electrical wire 36 in a different portion along the longitudinal direction, there may also be a case where the different fixing means corresponding to the role is adopted. That is to say, the different fixing means may be adopted in the portion functioning as the first electrical wire 32 and the portion functioning as the second electrical wire in the electrical wire 430 described above. Needless to say, the same fixing means may be adopted in the portion functioning as the first electrical wire 32 and the portion functioning as the second electrical wire in the electrical wire 430 described above.

In the description in the embodiment, the same fixing means is adopted for all the first electrical wires 32 when there are the plurality of first electrical wires 32, however, this configuration is not necessary. When there are the plurality of first electrical wires 32, there may also be a case where the different fixing means are adopted for some of the first electrical wires 32 and some other first electrical wires 32. The same applies to the second electrical wire 34 and the third electrical wire 36.

FIG. 14 is a schematic cross-sectional view illustrating a wire harness 510 according to a second modification example.

The wire harness 510 further includes a reinforcement member 60. The fixing means in the first fixing position and the fixing means in the second fixing position in the wire harness 510 are similar to those in the wire harness 10 described above, but are not limited thereto.

The reinforcement member 60 is formed to have a height dimension larger than a height of the stacked electrical wires 30. The reinforcement member 60 is provided to be located on both sides of the electrical wires 30 on the base material 20. At this time, the plurality of first electrical wires 32 may be disposed between the adjacent reinforcement members 60, or one first electrical wire 32 is also applicable. There may be the electrical wire 30 having direct contact with the reinforcement member 60, or may not be such an electrical wire 30. When there is the electrical wire 30 having direct contact with the reinforcement, member 60, the electrical wire 30 may be the first electrical wire 32, the second electrical wire 34, or the electrical wire subsequent to the third electrical wire 36.

The reinforcement member 60 is formed of a resin or metal, for example, as a material. At this time, the reinforcement member 60 is preferably formed to have higher stiffness than the electrical wire 30. The reinforcement member 60 is provided along the path of the electrical wire 30. At this time, the reinforcement member 60 is preferably provided continuously along the longitudinal direction of the electrical wire 30, but may also be intermittently provided. The reinforcement member 60 has a rectangular shape in cross section in the example illustrated in FIG. 14, but may also have the other polygonal shape or a circular shape, thus the shape of the reinforcement member 60 is appropriately set.

The reinforcement member 60 is fixed to the base material 20. The reinforcement member 60 is fixed to the base material 20 by a method such as the sewing with the thread 40, the ultrasonic welding, the fixation using the inclusion 50 having the adhesiveness or the stickiness in the manner similar to the electrical wire 30, for example. At this time, the reinforcement member 60 may be fixed to the same fixing means as that in the first fixing position, the same fixing means as that in the second fixing position, or the fixing means different from those in the first fixing position and the second fixing position. The reinforcement member 60 may be fixed to the base material 20 by a method other than the sewing with the thread 40, the ultrasonic welding, the fixation using the inclusion 50 having the adhesiveness or the stickiness.

An interval between the adjacent reinforcement members 60 needs to be set smaller than a press member 90 having a smallest outer shape of a pressing portion in the press member 90 which has a possibility of pressing the wire harness 510 to apply a large external force when the press member 90 is disposed in the vehicle. A shoe heel or a tip of an umbrella, for example, is considered as the press member 90.

When the electrical wire 30 is stepped in the state where the electrical wire 30 is fixed to and stacked on the base material 20, for example, there is a possibility that the electrical wire 30 cannot absorb an impact of the stepping sufficiently, and is damaged. Particularly, there is a possibility that the wire harness 510 is stepped from a side of a vehicle interior and a large force is applied to the wire harness 510 such as a floor harness disposed on a floor of a vehicle, and there may be a case where a protection cover having relatively high stiffness such as a trim is not disposed between the wire harness 510 and an interior space. Even in such a case, according to the present embodiment, the reinforcement member 60 is provided in the wire harness 510, thereby being able to suppress an excess force on the electrical wire 30.

There may also be a case where there is no reinforcement member 60 on a side of an end edge portion of the base material 20 for the electrical wire 30 located on a side of the end portion of the base material 20 in a width direction. That is to say, there may also be a case where formed in the wire harness 510 are not only a first reinforcement region A1 in which the reinforcement member 60 is provided to be located on the both sides of the electrical wire 30 on the base material 20 but also a second reinforcement region A2 in which the reinforcement member 60 is provided to be located only on one side of the electrical wire 30 on the base material 20. In this case, for example, when the wire harness 510 is disposed in the vehicle, the other member 100 needs to be disposed near the wire harness 510 or the wire harness 510 needs to be disposed in a concave-shaped groove, for example. Accordingly, the other member 100 or an edge portion of the groove can doubles as the reinforcement member 60.

The reinforcement member 60 has the effect described above even in a case where the electrical wire 30 is provided only in a single layer on the base material 20. Accordingly, also considered is a case where when there is a potion where the electrical wire 30 is provided only in the single layer on the base material 20 in each wire harness described above, the reinforcement member 60 is provided in that portion. Furthermore, the reinforcement member 60 can also be applied to a wire harness in which the, electrical wire is provided only in a single layer on the base material 20 and a wire harness in which the electrical wire is stacked on the base material 20 by a method different from that in the present invention.

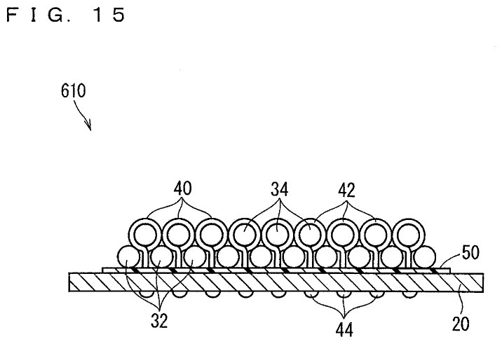

FIG. 15 is a schematic cross-sectional view illustrating a wire harness 610 according to a third modification example.

The wire harness 610 is similar to the wire harnesses 110A and 210A described above in that the first fixing means is adopted in the second fixing position. However, a configuration of sewing in the first fixing means is different between the wire harness 610 and the wire harnesses 110A and 210A described above.

Specifically, the thread 40 sews only the second electrical wire 34 to the base material 20 without rolling the first electrical wire 32 together. At this time, one second electrical wire 34 is disposed between the two first electrical wires 32, and the thread 40 sewing the second electrical wire 34 passes through the two first electrical wires 32 below the second electrical wire 34 and is sewn to the base material 20.

Furthermore, in the description described above, one of the first fixing means, the second fixing means, and the third fixing means is adopted as the fixing means, however, this configuration is not necessary. There may also be a case where adopted as the fixing means is a fixing means, such as a fixing means of winding a banding band or a one-sided adhesive tape around the base and the electrical wire 30 using the banding band or the one-sided adhesive tape, other than the first fixing means, the second fixing means, and the third fixing means.

In the description described above, the electrical wire 30 is connected to a connection member such as the connector C in the portion extending from the base material 20, however, this configuration is not necessary. The electrical wire 30 may be connected to the connection member such as the connector C on the base material 20.

The configurations described in the embodiments and modification examples thereof can be appropriately combined as long as they are not contradictory.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

10 wire harness

20 base material

30 electrical wire

32 first electrical wire

34 second electrical wire

36 third electrical wire

40 thread

50 inclusion

60 reinforcement member

1. A wire harness, comprising:
a base material; and
electrical wires including a first electrical wire and a second electrical wire and disposed to be stacked in layers on the base material, wherein
a fixing means in a first fixing position for keeping the first electrical wire disposed on the base material and a fixing means in a second fixing position for keeping the second electrical wire disposed on the first electrical wire are different from each other,
the first electrical wire and the second electrical wire are not partitioned by a shield member, and
the electrical wires includes an electrical wire curved on the base material.

2. The wire harness according to claim 1, wherein
two fixing means of a first fixing means using a sewing by a thread, a second fixing means using ultrasonic welding, and a third fixing means using an inclusion having adhesiveness or stickiness are adopted as the fixing means in the first fixing position and the second fixing position.

3. The wire harness according to claim 2, wherein
the fixing means in the first fixing position is the first fixing means or the third fixing means.

4. The wire harness according to claim 3, wherein
the fixing means in the first fixing position is the first fixing means, and
the fixing means in the second fixing position is the second fixing means.

5. The wire harness according to claim 1, further comprising
a reinforcement member formed to have a height dimension larger than a height of the electrical wires which is stacked, and provided on both sides of the electrical wires on the base material.
